(19) United States
(12) Patent Application Publication
(10) Pub. No.: US 2024/0331944 A1
(43) Pub. Date: Oct. 3, 2024

(54) CERAMIC ELECTRONIC DEVICE AND MANUFACTURING METHOD OF THE SAME

(71) Applicant: TAIYO YUDEN CO., LTD., Tokyo (JP)

(72) Inventors: Yuji TAKITA, Tokyo (JP); Yusuke KOWASE, Tokyo (JP); Maiko YAMANE, Tokyo (JP); Yu SUGAWARA, Tokyo (JP)

(73) Assignee: TAIYO YUDEN CO., LTD., Tokyo (JP)

(21) Appl. No.: 18/616,920

(22) Filed: Mar. 26, 2024

(30) Foreign Application Priority Data
Mar. 31, 2023 (JP) 2023-059323

(51) Int. Cl. H01G 4/224; H01G 4/232; H01G 4/30

(52) U.S. Cl. CPC H01G 4/224; H01G 4/2325; H01G 4/30

(57) ABSTRACT

A ceramic electronic device includes a multilayer chip having a multilayer portion in which each of a plurality of dielectric layers and each of a plurality of internal electrode layers are alternately stacked. The multilayer chip has a side margin outside a capacity section. The multilayer chip has cover layers on an upper face and a lower face of a capacity section. Each of the side margin and the cover layers has, on a side of an outer surface, a high concentration portion of a subcomponent of at least one of Si, Mn, Cu, Fe, V, Ni, B, Mg, Ho, Dy, Er, Tm, Yb, Gd, Li, Co, Sm and Y. A concentration of the subcomponent of the high concentration portion is higher than that of a portion closer to the capacity section than the high concentration portion.

### CROSS-REFERENCE TO RELATED APPLICATION

This application is based upon and claims the benefit of priority of the prior Japanese Patent Application No. 2023-059323, filed on Mar. 31, 2023, the entire contents of which are incorporated herein by reference.

### FIELD

A certain aspect of the present disclosure relates to a ceramic electronic device and a manufacturing method of the ceramic electronic device.

### BACKGROUND

Ceramic electronic devices such as multilayer ceramic capacitors are used in high frequency communication systems, typified by mobile phones (see, for example, Japanese Patent Application Publication No. 2020-35788).

### SUMMARY OF THE INVENTION

According to an aspect of the embodiments, there is provided a ceramic electronic device including: a multilayer chip having a multilayer portion in which each of a plurality of dielectric layers and each of a plurality of internal electrode layers are alternately stacked, wherein the plurality of internal electrode layers are extracted alternately to two end faces of the multilayer chip facing each other, wherein the multilayer chip has a side margin outside a capacity section in which the plurality of dielectric layers and the plurality of internal electrode layers face each other, in a third direction orthogonal to a first direction in which the plurality of internal electrode layers face each other and a second direction in which the two end faces face each other, wherein the multilayer chip has cover layers of which a main component is ceramic, on an upper face and a lower face of the capacity section in the first direction, wherein each of the side margin and the cover layers has, on a side of an outer surface, a high concentration portion of a subcomponent of at least one of Si, Mn, Cu, Fe, V, Ni, B, Mg, Ho, Dy, Er, Tm, Yb, Gd, Li, Co, Sm and Y, and wherein a concentration of the subcomponent of the high concentration portion is higher than that of a portion closer to the capacity section than the high concentration portion.

According to another aspect of the embodiments, there is provided a ceramic electronic device including: a multilayer chip having a multilayer portion in which each of a plurality of dielectric layers and each of a plurality of internal electrode layers are alternately stacked, wherein the plurality of internal electrode layers are extracted alternately to two end faces of the multilayer chip facing each other, wherein the multilayer chip has a side margin outside a capacity section in which the plurality of dielectric layers and the plurality of internal electrode layers face each other, in a third direction orthogonal to a first direction in which the plurality of internal electrode layers face each other and a second direction in which the two end faces face each other, wherein the multilayer chip has cover layers of which a main component is ceramic, on an upper face and a lower face of the capacity section in the first direction, wherein each of the side margin and the cover layers has, on a side of an outer surface, a high concentration portion of a subcomponent of at least one of Si, Mn, Cu, Fe, V, Ni, B, Mg, Ho, Dy, Er, Tm, Yb, Gd, Li, Co, Sm and Y, wherein a concentration of the subcomponent of the high concentration portion is higher than that of a portion closer to the capacity section than the high concentration portion, and wherein the high concentration portion is located within a range of 5.2% to 76% from the outer surface with respect to a thinner one of a thickness of the side margin and a thickness of the cover layers.

According to another aspect of the embodiments, there is provided a manufacturing method of a ceramic electronic device including: forming each of plurality of internal electrode patterns on each of a plurality of dielectric green sheets; forming each of a plurality of dielectric patterns around each of the plurality of internal electrode patterns on each of the plurality of dielectric green sheets; forming a multilayer structure by, in a first direction, stacking the plurality of dielectric green sheets on which the plurality of internal electrode patterns and the plurality of dielectric patterns are formed, so that ends of the plurality of internal electrode patterns are alternately shifted in a second direction; arranging a subcomponent of at least one of Si, Mn, Cu, Fe, V, Ni, B, Mg, Ho, Dy, Er, Tm, Yb, Gd, Li, Co, Sm and Y on both ends of the multilayer structure in a third direction orthogonal to the first direction and the second direction by attachment or impregnation; and firing the multilayer structure.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4 is an enlarged cross-sectional view of a vicinity of an external electrode;

FIG. 5 illustrates a high concentration portion;

FIG. 6 illustrates an EPMA line analysis;

FIG. 7 illustrates a graph before smoothing and a graph after smoothing;

FIG. 8 is a diagram illustrating normalized concentration;

FIG. 9 illustrates points of dD/dd=35 and inflection points;

FIG. 10 illustrates a flow of a manufacturing method of a multilayer ceramic capacitor;

FIG. 11A and FIG. 11B illustrate a forming process of an internal electrode;

FIG. 12 illustrates a crimping process; and

FIG. 13 illustrates a case where a side margin portion is attached.

### DETAILED DESCRIPTION

Ceramic electronic devices such as multilayer ceramic capacitors can be manufactured by firing powder materials. At this time, since the sintered state varies greatly depending on the composition of the dielectric, a difference in color occurs between the side and cover portions. At this time, the product may be determined to be defective by visual inspection. Therefore, it may be possible to add subcomponents such as silica to adjust the color tone. However, when the subcomponent diffuses into the capacity section, the subcomponent adversely affects electrical characteristics such as electrostatic capacity.

Hereinafter, an exemplary embodiment will be described with reference to the accompanying drawings.

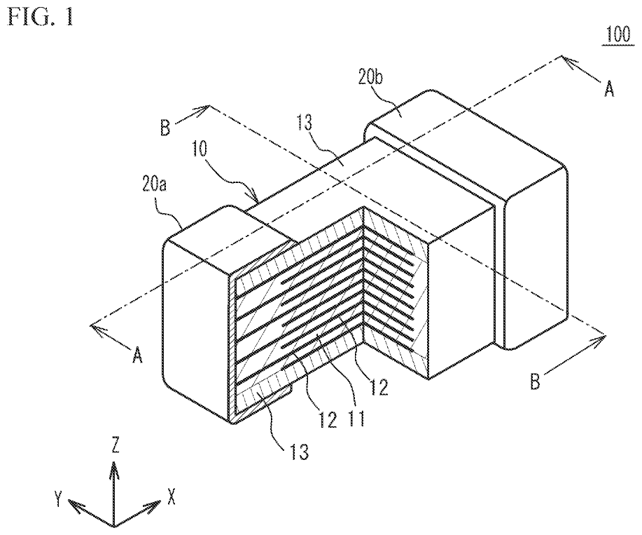

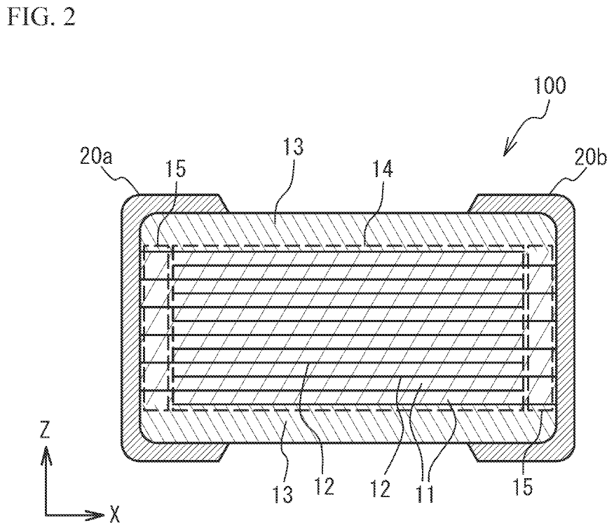

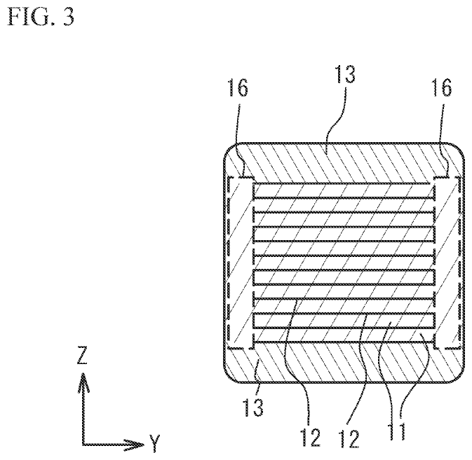

(Embodiment) FIG. 1 illustrates a perspective view of a multilayer ceramic capacitor 100 in accordance with an embodiment, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes a multilayer chip 10 having a rectangular parallelepiped shape, and external electrodes 20a and 20b that are respectively provided on two end faces of the multilayer chip 10 facing each other. Among four faces other than the two end faces of the multilayer chip 10, two faces other than the upper face and the lower face in the stacking direction are referred to as side faces. Each of the external electrodes 20a and 20b extends to the upper face and the lower face in the stacking direction and the two side faces of the multilayer chip 10. However, the external electrodes 20a and 20b are spaced from each other.

In FIG. 1 to FIG. 3, a Z-axis direction (first direction) is the stacking direction. The Z-axis direction is a direction in which internal electrode layers face each other. An X-axis direction (second direction) is a longitudinal direction of the multilayer chip 10. The X-axis direction is a direction in which the two end faces of the multilayer chip 10 are opposite to each other and in which the external electrode 20a is opposite to the external electrode 20b. A Y-axis direction (third direction) is a width direction of the internal electrode layers. The Y-axis direction is a direction in which the two side faces of the multilayer chip 10 are opposite to each other. The X-axis direction, the Y-axis direction and the Z-axis direction are vertical to each other.

The multilayer chip 10 has a structure designed to have dielectric layers 11 and internal electrode layers 12 alternately stacked. The dielectric layer 11 contains a ceramic material acting as a dielectric material. End edges of the internal electrode layers 12 are alternately exposed to a first end face of the multilayer chip 10 and a second end face of the multilayer chip 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal electrode layer 12 is not particularly limited, but is a base metal such as Ni (nickel), Cu (copper), Sn (tin). As a main component of the internal electrode layers 12, noble metals such as Pt (platinum), Pd (palladium), Ag (silver), Au (gold), and alloys containing these may be used. It is preferable that the average thickness per layer of the internal electrode layer 12 in the Z-axis direction is, for example, 0.5 μm or less, or 00.4 μm or less. The thickness of the internal electrode layer 12 is determined by observing the cross section of the multilayer ceramic capacitor 100 with a SEM (scanning electron microscope), measuring the thickness at 10 points for each of the 10 different internal electrode layers 12, and calculating the average value of all the measurement points.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr₂O₃ (0≤x≤1, 0≤y≤1, 0≤z≤1) having a perovskite structure. Ba_{1-x-y}CaₓSryTi_{1-z}Zr_{z}O₃ may be barium strontium titanate, barium calcium titanate, barium zirconate, barium titanate zirconate, calcium titanate zirconate, barium calcium titanate zirconate or the like. For example, the concentration of the main component ceramic material in the dielectric layer 11 is 90 at % or more. The thickness of the dielectric layer 11 is, for example, 1.0 μm or less, or 0.8 μm or less. The thickness of the dielectric layer 11 is determined by observing the cross section of the multilayer ceramic capacitor 100 with a SEM (scanning electron microscope), measuring the thickness of each of the 10 different dielectric layers 11 at 10 points, and calculating the average value of all measurement points.

Additives may be added to the dielectric layer 11. As additives to the dielectric layer 11, zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

As illustrated in FIG. 2, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 3, in the multilayer chip 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

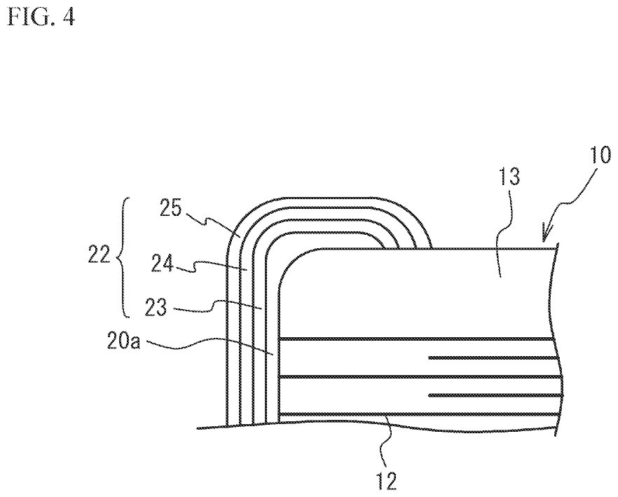

FIG. 4 is an enlarged cross-sectional view of the vicinity of the external electrode 20a. In FIG. 4, hatches are omitted. As illustrated in FIG. 4, a plated layer 22 may be provided on the outer surface of the external electrode 20a, using the external electrode 20a as a base layer. The external electrode 20a has Cu as a main component. The external electrode 20a may contain a glass component. The plated layer 22 mainly contains metals such as Cu, Ni, aluminum (Al), zinc (Zn), and Sn, or alloys of two or more of these metals. The plated layer 22 may be a plated layer of a single metal component, or may be a plurality of plated layers of mutually different metal components. For example, the plated layer 22 has a structure in which a first plated layer 23, a second plated layer 24, and a third plated layer 25 are formed in order from the external electrode 20a side. The first plated layer 23 is, for example, a Cu-plated layer. The second plated layer 24 is, for example, a Ni plated layer. The third plated layer 25 is, for example, a Sn-plated layer. Although FIG. 4 illustrates the external electrode 20a, the plated layer 22 may be similarly provided on the outer surface of the external electrode 20b.

A multilayer ceramic capacitor can be manufactured by simultaneously firing the powder material for the dielectric layer, the powder material for the internal electrode layer, and so on. For example, in order to suppress discontinuities in the internal electrode layers, firing may be performed at a high temperature increase rate of 1000° C./h or more. At this time, since the sintered state varies greatly depending on the composition of the dielectric, a difference in color occurs between the cover layer and the side margin. If a multilayer ceramic capacitor with a difference in color is visually inspected, the multilayer ceramic capacitor may be determined to be defective. Therefore, in order to adjust the color of the side margin, it is conceivable to add a large amount of subcomponents such as silica in advance to adjust the color. However, in this case, the added subcomponent diffuses into the capacity section during the firing process, which adversely affects electrical properties such as electrostatic capacity.

On the other hand, the multilayer ceramic capacitor 100 according to the present embodiment has a configuration that allows the color tone of the external appearance to be adjusted while ensuring the electrical characteristics. The details will be explained below.

In this embodiment, the side margin 16 and the cover layer 13 contain a subcomponent for adjusting the color tone (hereinafter referred to as a color tone adjustment component). As the color tone adjustment components, at least one of silicon (Si), manganese (Mn), copper (Cu), iron (Fe), vanadium (V), nickel (Ni), boron (B), magnesium (Mg), holmium (Ho), dysprosium (Dy), erbium (Er), thulium (Tm), ytterbium (Yb), gadolinium (Gd), lithium (Li), cobalt (Co), samarium (Sm), and yttrium (Y) may be used. Since the side margin 16 and the cover layer 13 contain the color tone adjustment component, the color tone of the outer surfaces of the side margin 16 and the cover layer 13 can be adjusted. For example, the solid solution state of the additive changes, resulting in a whitish appearance. This makes it easier to pass the visual inspection of the multilayer ceramic capacitor 100 according to the present embodiment.

In the side margin 16 and the cover layer 13, the color tone adjustment component may exist in the form of a single element or in the form of an oxide. For example, the color tone adjustment component may exist in the form of oxide crystals or in the form of glass.

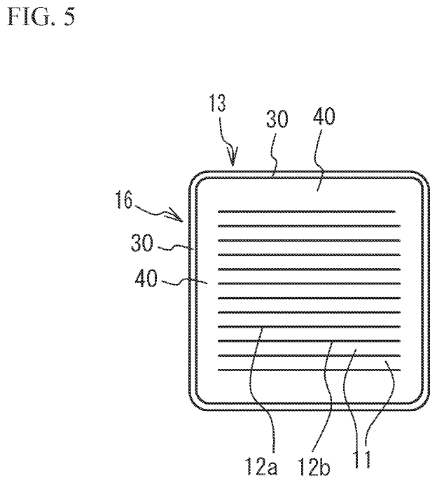

As illustrated in FIG. 5, the side margin 16 and the cover layer 13 include a high concentration portion 30 in which the concentration of the color tone adjustment component is higher on the side closer to the outer surface than on the side closer to the capacity section 14. Thereby, the color tone of the outer surfaces of the side margin 16 and the cover layer 13 can be adjusted. On the other hand, in the side margin 16 and the cover layer 13, since the concentration of the color tone adjustment component on the side of the capacity section 14 is low, diffusion of the color tone adjustment component into the capacity section 14 is suppressed. Thereby, deterioration of the electrical characteristics of the multilayer ceramic capacitor 100 can be suppressed. Note that a portion closer to the capacity section 14 than the high concentration portion 30 is referred to as a low concentration portion 40. In FIG. 5, hatching is omitted.

From the above, it is possible to adjust the color tone of the appearance of the multilayer ceramic capacitor 100 according to the present embodiment while ensuring electrical characteristics.

For example, when an EPMA (Electron Probe Micro Analyzer) line spectrum is acquired in the thickness direction of the side margin 16 and the cover layer 13 for the density of the color tone adjustment component, an inflection point appears in the concentration change of the color tone adjustment component. Whether or not an inflection point has appeared in the concentration change of the color tone adjustment component can be confirmed by the following procedure. Note that the thickness direction of the side margin 16 is the Y-axis direction, and the thickness direction of the cover layer 13 is the Z-axis direction.

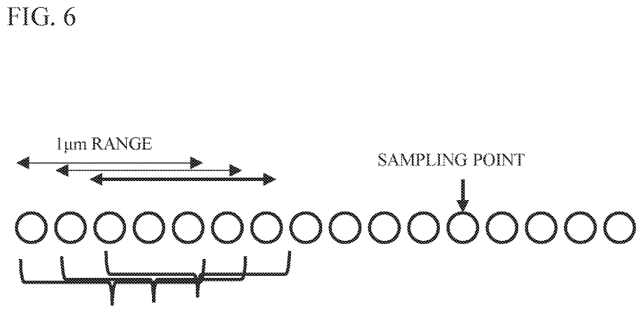

First, as illustrated in FIG. 6, EPMA line analysis is performed in the thickness direction of the side margin 16 and the cover layer 13 at a predetermined sampling period. Each circle in FIG. 6 indicates a sampling point. In FIG. 6, the sampling interval is, for example, 0.25 μm. Next, the average intensity value in a range of 0.5 μm before and after each sampling point is calculated. This calculated average intensity value is taken as the intensity value at each sampling point. By calculating and smoothing the moving average in this way, it is possible to measure intensity changes while suppressing the influence of noise.

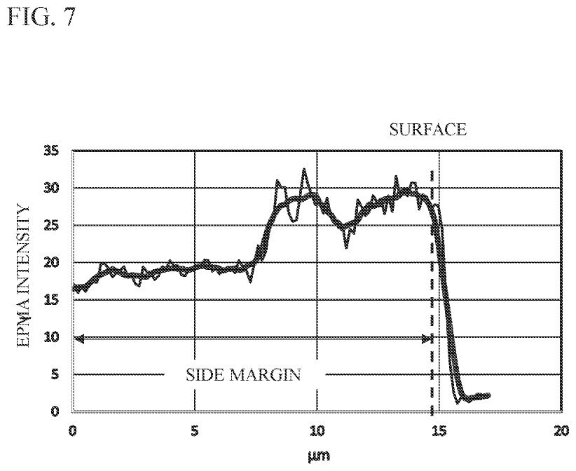

FIG. 7 illustrates a graph before smoothing and a graph after smoothing. Note that the horizontal axis in FIG. 7 represents the distance d (μm). “0” on the horizontal axis in FIG. 7 indicates, as an example, the boundary between the side margin 16 and the capacity section 14. In FIG. 7, the more to the right side of the horizontal axis, the more it progresses in the thickness direction of the side margin 16 and reaches the outer surface of the side margin 16. As illustrated in the graph of FIG. 7, in the side margin 16, the concentration of the color tone adjustment component is higher on the outer surface than on the capacity section 14 side.

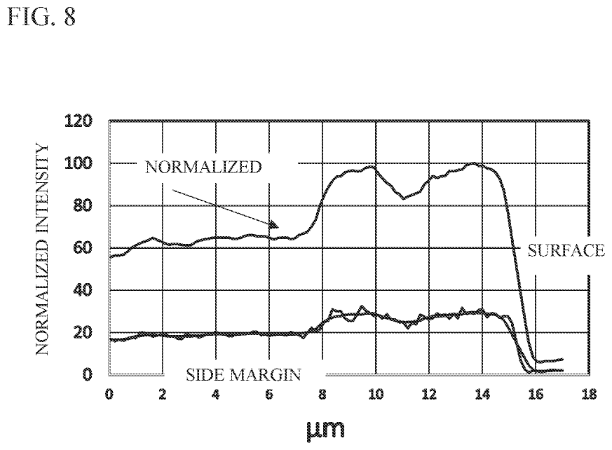

Next, the graph of the measured intensity change is normalized. By setting the intensity measured at each sampling point to intensity/maximum intensity×100, normalized intensity (D (%)) can be obtained. Thereby, the normalized intensity (D (%)) can be obtained by setting the intensity measured at each sampling point to intensity/maximum intensity×100. This normalization makes it possible to confirm the point of inflection even if there is variation in the absolute value of the concentration value. FIG. 8 is a diagram illustrating normalized concentration.

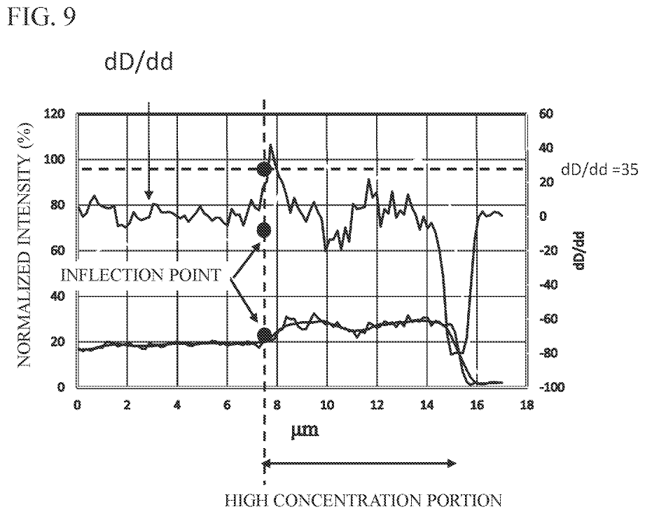

Next, the graph of the normalized intensity D (%) is differentiated by the distance d (μm) to calculate dD/dd. The point where dD/dd becomes 35 is defined as the inflection point. FIG. 9 illustrates points of dD/dd=35 and inflection points. In the multilayer ceramic capacitor 100 according to the present embodiment, the above-mentioned inflection point appears in the concentration change of the color tone adjustment component in the cover layer 13 and the side margin 16. As a result, it is confirmed that, in the side margin 16 and the cover layer 13, the concentration of the color tone adjustment component is kept low in the section close to the capacity section 14, and the concentration of the color tone adjustment component is locally high in the high concentration portion 30 close to the outer surface. When two or more types of color tone adjustment components are added, the concentration of the color tone adjustment components refers to the concentration when paying attention to any one of them.

For example, in the thickness direction of the side margin 16 and the cover layer 13, the portion from the above-mentioned inflection point to the outer surface can be defined as the high concentration portion 30.

If the above-mentioned inflection point is close to the outer surface of the side margin 16 and the cover layer 13, the amount of the color tone adjustment component will decrease, and there is a possibility that the color tone of the side margin 16 and the cover layer 13 cannot be adjusted sufficiently. Therefore, the inflection point is preferably located away from the outer surface. In this embodiment, in the thickness direction of the side margin 16 and the cover layer 13, it is preferable that the inflection point is separated by 5.2% or more from the outer surface with respect to the thickness of the thinner one of the side margin 16 and the cover layer 13. It is more preferable that the inflection point is 18% or more from the outer surface. It is still more preferable that the inflection point is 30% or more from the outer surface.

On the other hand, if the inflection point is close to the capacity section 14, there is a risk that the color tone adjustment component will diffuse into the capacity section 14. Therefore, it is preferable that the inflection point is located away from the capacity section 14. In this embodiment, in the thickness direction of the side margin 16 and the cover layer 13, it is preferable that the inflection point is separated from the outer surface by 76% or less with respect to the thickness of the thinner one of the side margin 16 and the cover layer 13. It is more preferable that the inflection point is separated by 67% or less with respect to the thickness of the thinner one of the side margin 16 and the cover layer 13. It is still more preferable that the inflection point is separated by 61% or less with respect to the thickness of the thinner one of the side margin 16 and the cover layer 13.

If the concentration of the color tone adjustment component in the high concentration portion 30 is low, there is a possibility that the color tone of the side margin 16 and the cover layer 13 cannot be adjusted sufficiently. Therefore, it is preferable to set a lower limit on the concentration of the color tone adjustment component in the high concentration portion 30. In the present embodiment, the concentration of the color tone adjustment component in the high concentration portion 30 is preferably 2.5 at % or more, more preferably 2.75 at % or more, and still more preferable 3.0 at % or more. Note that the concentration of the color tone adjustment component here refers to the concentration when the B site (for example, Ti) of the main component ceramic having a perovskite structure included in the side margin 16 and the cover layer 13 is set to 100 at %. The concentration of the color tone adjustment component in the high concentration portion 30 can be measured by, for example, LA-ICP-MS.

On the other hand, if the concentration of the color tone adjustment component in the high concentration portion 30 is high, necking, in which the multilayer chips stick together, may occur when firing a plurality of multilayer chips. Therefore, it is preferable to set an upper limit on the concentration of the color tone adjustment component in the high concentration portion 30. In the present embodiment, the concentration of the color tone adjustment component in the high concentration portion 30 is preferably 9.0 at % or less, more preferably 8.5 at % or less, and even more preferably 8.0 at % or less.

If the concentration of the color tone adjustment component in the low concentration portion 40 is high, there is a risk that the color tone adjustment component will diffuse into the capacity section 14. Therefore, it is preferable to set an upper limit on the concentration of the color tone adjustment component in the low concentration portion 40. In the present embodiment, the concentration of the color tone adjustment component in the low concentration portion 40 is preferably 6.0 at % or less, more preferably 5.5 at % or less, and even more preferably 5.0 at % or less.

On the other hand, if the concentration of the color tone adjustment component in the low concentration portion 40 is low, Si present in the capacity section 14 may diffuse into the cover layer 13 and the side margin 16, causing a change in characteristics. Therefore, it is preferable to set a lower limit to the concentration of the color tone adjustment component in the low concentration portion 40. In the present embodiment, the concentration of the color tone adjustment component in the low concentration portion 40 is preferably 2.0 at % or more, more preferably 2.25 at % or more, and even more preferably 2.5 at % or more.

If the difference in thickness between the high concentration portion 30 in the side margin 16 and the high concentration portion 30 in the cover layer 13 is large, the difference in color tone may become large. Therefore, it is preferable that the difference in thickness between the high concentration portion 30 in the side margin 16 and the high concentration portion 30 in the cover layer 13 is small. In the present embodiment, the ratio of the thickness of the high concentration portion 30 in the cover layer 13 to the thickness of the high concentration portion 30 in the side margin 16 is preferably 0.75 or more and 1.26 or less.

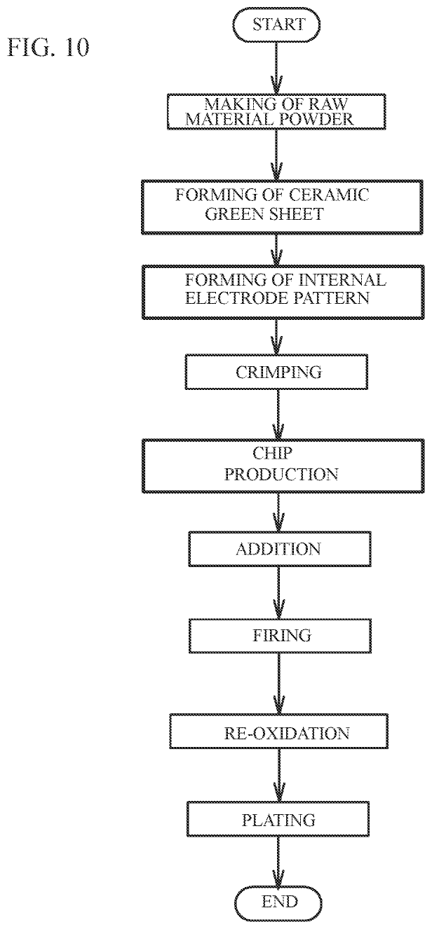

Next, a description will be given of a manufacturing method of the multilayer ceramic capacitors 100. FIG. 10 illustrates a manufacturing method of the multilayer ceramic capacitor 100.

(Making process of raw material powder) A dielectric material for forming the dielectric layer 11 is prepared. An A site element and a B site element are included in the dielectric layer 11 in a sintered phase of grains of ABO₃. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate. Various methods can be used as a synthesizing method of the ceramic structuring the dielectric layer 11. For example, a solid-phase method, a sol-gel method, a hydrothermal method or the like can be used. The embodiments may use any of these methods.

A predetermined additive compound is added to the obtained dielectric powder according to the purpose. As additives to the dielectric layer 11, zirconium, hafnium, magnesium, manganese, molybdenum, vanadium, chromium, rare earth elements (yttrium, samarium, europium, gadolinium, terbium, dysprosium, holmium, erbium, thulium, and ytterbium) or an oxide of cobalt, nickel, lithium, boron, sodium, potassium or silicon, or a glass including cobalt, nickel, lithium, boron, sodium, potassium or silicon.

For example, a ceramic material is prepared by wet-mixing a compound containing an additive compound with a ceramic raw material powder, drying and pulverizing the mixture. For example, the ceramic material obtained as described above may be pulverized to adjust the particle size, if necessary, or may be combined with a classification process to adjust the particle size. Through the above steps, a dielectric material is obtained.

(Forming process of ceramic green sheet) Next, a binder such as polyvinyl butyral (PVB) resin, an organic solvent such as ethanol or toluene, and a plasticizer are added to the obtained dielectric material and wet-mixed. Using the obtained slurry, a ceramic green sheet 51 is formed on the substrate by, for example, a die coater method or a doctor blade method, and dried. The substrate is, for example, polyethylene terephthalate (PET) film. The process is not illustrated.

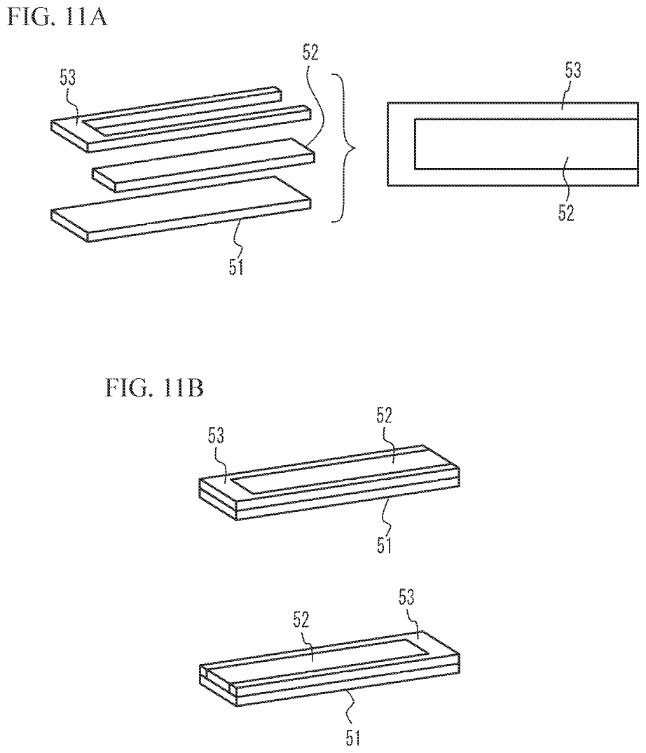

(Forming process of internal electrode pattern) Next, as illustrated in FIG. 11A, a metal conductive paste for forming internal electrodes containing an organic binder is printed on the surface of the ceramic green sheet 51 by screen printing, gravure printing, or the like to form internal electrodes. Thus, an internal electrode pattern 52 for layers is arranged. Ceramic particles may be added to the metal conductive paste as a co-material. The main component of the ceramic particles is not limited. However, it is preferable that the main component of the ceramic particles is the same as the main component of the dielectric layer 11.

Next, a binder such as ethyl cellulose and an organic solvent such as terpineol are added to the dielectric pattern material obtained in the making process of the raw material powder, and the mixture is kneaded in a roll mill to form a dielectric pattern paste for the reverse pattern layer. As illustrated in FIG. 11A, a dielectric pattern 53 is formed by printing the resulting slurry in the peripheral region, where the internal electrode pattern 52 is not printed, on the ceramic green sheet 51 to cause the dielectric pattern 53 and the internal electrode pattern 52 to form a flat surface. The ceramic green sheet 51 on which the internal electrode pattern 52 and the dielectric pattern 53 are printed is referred to as a stack unit.

Thereafter, as illustrated in FIG. 11B, a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. For example, the number of the internal electrode pattern 52 is 100 to 500.

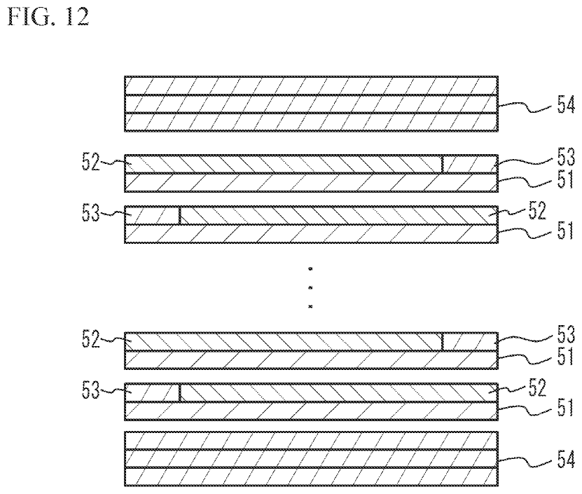

(Crimping process) Next, as illustrated in FIG. 12, a predetermined number (for example, 2 to 10) cover sheet 54 are stacked on the stacked stack units and under the stacked stack units. After that, the stacked structure is thermally crimped. The above-mentioned dielectric material or the above-mentioned dielectric pattern material can be used as the ceramic material of the cover sheets 54.

(Chip production process) The obtained ceramic multilayer structure is cut into chips to a predetermined size.

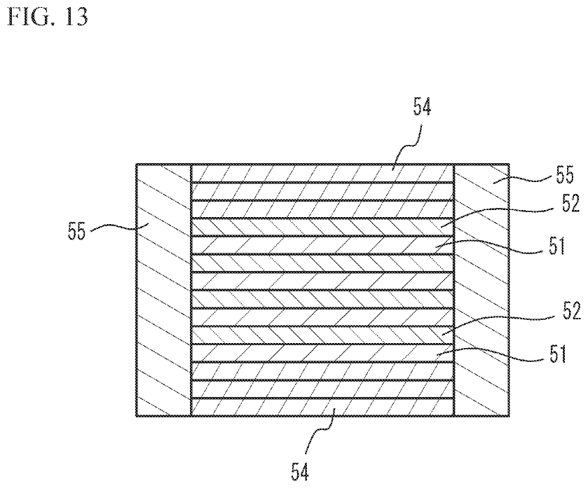

The side margin portion may be attached or coated on the side surface of the multilayer portion. Specifically, as illustrated in FIG. 13, a multilayer portion is obtained by alternately tacking the ceramic green sheets 51 and the internal electrode patterns 52 having the same width as the ceramic green sheets 51. Next, a sheet formed of dielectric pattern paste may be attached as the side margin portion 55 to the side surface of the multilayer portion.

(Addition process) Next, the chipped ceramic multilayer structure is chamfered by barrel polishing, and the binder is removed in an air atmosphere or nitrogen atmosphere. Thereafter, a color tone adjustment component is added to the surface portion of the ceramic multilayer structure by dipping. For example, when using silica as the color tone adjustment component, colloidal silica is impregnated. Through this dipping step, the surface of the portion corresponding to the side margin 16 and the cover layer 13 can be impregnated with the precursor of the color tone adjustment component. The amount of impregnation of the color tone adjustment component precursor can be adjusted by adjusting the dipping time. Note that the amount of impregnation can also be adjusted by changing the solvent viscosity, stirring time, solution temperature, or the like.

Note that the color tone adjustment component may be added by a method other than dipping. For example, a color tone adjustment component may be attached to the chip surface by chemical vapor deposition (CVD) or the like and allowed to penetrate in the high temperature range of the firing process.

(Firing process) The binder is removed from the resulting ceramic multilayer structure in N₂ atmosphere. After that, a metal paste to be the base layer of the external electrodes 20a and 20b is applied to the resulting ceramic multilayer by a dipping or the like. The resulting ceramic multilayer structure is fired in a reducing atmosphere with an oxygen partial pressure of 10-12 to 10-9 MPa in a temperature of 1160° C. to 1280° C. for 5 minutes to 10 hours.

(Re-oxidation process) In order to return oxygen to the partially reduced main phase barium titanate of the dielectric layer 11 fired in a reducing atmosphere, N₂ and water vapor are mixed at about 1000° C. to an extent that the internal electrode layer 12 is not oxidized, heat treatment may be performed in gas or in the atmosphere at 500° C. to 700° C. This process is called a re-oxidation process.

(Plating process) After that, metal layers such as copper, nickel, and tin may be formed on the external electrodes 20a and 20b by plating. Thus, the multilayer ceramic capacitor 100 is manufactured.

According to the manufacturing method according to the present embodiment, the side margin 16 and the cover layer 13 are impregnated with or adhered to the color adjustment component in the portions corresponding to the outer surfaces of the side margin 16 and the cover layer 13 and then fired. Therefore, a portion with a high concentration of the color tone adjustment component can be formed on the outer surface in the side margin 16 and the cover layer 13. And a portion with a low concentration of the color tone adjustment component can be formed on the side closer to the capacity section 14. For example, the high concentration portion 30 and the low concentration portion 40 described above can be formed.

Note that in each of the above embodiments, a multilayer ceramic capacitor has been described as an example of a multilayer ceramic electronic device, but the present invention is not limited thereto. For example, other multilayer ceramic electronic devices such as varistors and thermistors may be used.

### Example

Hereinafter, a multilayer ceramic capacitor according to the above embodiment was manufactured and its characteristics were investigated.

(Example 1) A Ni internal electrode pattern was printed on a dielectric green sheet. A dielectric pattern was printed around the internal electrode pattern. A plurality of stack units were stacked so that the internal electrode patterns were alternately shifted in the X-axis direction, crimped, and cut to obtain a ceramic multilayer structure.

The produced ceramic multilayer structure was chamfered with a barrel, and the binder was removed. In Example 1, Si was used as the color tone adjustment component. By impregnating colloidal silica into the chip by dipping, the chip margin was impregnated with the silica precursor. The amount of the silica precursor impregnated was adjusted by the dipping time. In Example 1, the dipping time was 5 seconds. The impregnation depth of the Si component was 1 μm. After dipping, heat treatment was performed at 200° C. in a nitrogen atmosphere to remove excess organic solvent. A multilayer ceramic capacitor was fabricated by high-speed firing (temperature increase rate: 1000° C./h) of the ceramic multilayer structure to which a Si component was added in an N₂—H₂-wet atmosphere, and by baking external electrodes and performing plating.

After firing, the thickness of the cover layer was 17 μm. The thickness of the side margin was 13 μm. EPMA line analysis was performed on the side margin and the cover layer to measure the concentration of the color tone adjustment component, detect the inflection point, and define the portion from the inflection point to the outer surface as a high concentration portion. The range of the high concentration portion in the cover layer was 1.1 μm from the outer surface. This corresponds to 6.5% of the thickness of the cover layer. The range of the high concentration portion in the side margin was 1.0 μm from the outer surface. This corresponds to 8.5% of the thickness of the side margin. The ratio of the thickness of the high concentration portion in the cover layer/thickness of the high concentration portion in the side margin was 1.10.

(Example 2) In Example 2, the dipping time was 5 seconds. The impregnation depth of the Si component was 1 μm. After firing, the thickness of the cover layer was 21 μm. The thickness of the side margin was 17 μm. The range of the high concentration portion in the cover layer was 1.2 μm from the outer surface. This corresponds to 5.2% of the thickness of the cover layer. The range of the high concentration portion in the side margin was 1.0 μm from the outer surface. This corresponds to 6.5% of the thickness of the side margin. The ratio of the thickness of the high concentration portion in the cover layer/thickness of the high concentration portion in the side margin was 1.20. Other conditions were the same as in Example 1.

(Example 3) In Example 3, the dipping time was 60 seconds. The impregnation depth of the Si component was 9 μm. After firing, the thickness of the cover layer was 17 μm. The thickness of the side margin was 13 μm. The range of the high concentration portion in the cover layer was 9.1 μm from the outer surface. This corresponds to 49% of the thickness of the cover layer. The range of the high concentration portion in the side margin was 7.5 μm from the outer surface. This corresponds to 65% of the thickness of the side margin. The ratio of the thickness of the high concentration portion in the cover layer/thickness of the high concentration portion in the side margin was 1.21. Other conditions were the same as in Example 1.

(Example 4) In Example 4, the dipping time was 60 seconds. The impregnation depth of the Si component was 9 μm. After firing, the thickness of the cover layer was 21 μm. The thickness of the side margin was 17 μm. The range of the high concentration portion in the cover layer was 9.1 μm from the outer surface. This corresponds to 40% of the thickness of the cover layer. The range of the high concentration portion in the side margin was 7.2 μm from the outer surface. This corresponds to 49% of the thickness of the side margin. The ratio of the thickness of the high concentration portion in the cover layer/thickness of the high concentration portion in the side margin was 1.26. Other conditions were the same as in Example 1.

(Example 5) In Example 5, the dipping time was 120 seconds. The impregnation depth of the Si component was 12 μm. After firing, the thickness of the cover layer was 21 μm. The thickness of the side margin was 17 μm. The range of the high concentration portion in the cover layer was 13.0 μm from the outer surface. This corresponds to 62% of the thickness of the cover layer. The range of the high concentration portion in the side margin was 12.0 μm from the outer surface. This corresponds to 76% of the thickness of the side margin. The ratio of the thickness of the high concentration portion in the cover layer/thickness of the high concentration portion in the side margin was 1.08. Other conditions were the same as in Example 1.

(Example 6) In Example 6, B was used as the color tone adjustment component instead of Si, and the color tone adjustment component was attached to the surface of the chip margin portion by CVD without dipping. After firing, the thickness of the cover layer was 17 μm. The thickness of the side margin was 13 μm. The range of the high concentration portion in the cover layer was 5.0 μm from the outer surface. This corresponds to 30% of the thickness of the cover layer. The range of the high concentration portion in the side margin was 4.0 μm from the outer surface. This corresponds to 38% of the thickness of the side margin. The ratio of the thickness of the high concentration portion in the cover layer/thickness of the high concentration portion in the side margin was 1.25. Other conditions were the same as in Example 1.

(Example 7) In Example 7, Al was used as the color tone adjustment component instead of Si, and was deposited on the surface of the chip margin portion by CVD without dipping. After firing, the thickness of the cover layer was 17 μm. The thickness of the side margin was 13 μm. The range of the high concentration portion in the cover layer was 7.0 μm from the outer surface. This corresponds to 41% of the thickness of the cover layer. The range of the high concentration portion in the side margin was 6.0 μm from the outer surface. This corresponds to 54% of the thickness of the side margin. The ratio of the thickness of the high concentration portion in the cover layer/thickness of the high concentration portion in the side margin was 1.17. Other conditions were the same as in Example 1.

(Example 8) In Example 8, Ge was used as the color tone adjustment component instead of Si, and was deposited on the surface of the chip margin portion by CVD without dipping. After firing, the thickness of the cover layer was 17 μm. The thickness of the side margin was 13 μm. The range of the high concentration portion in the cover layer was 3.0 μm from the outer surface. This corresponds to 18% of the thickness of the cover layer. The range of the high concentration portion in the side margin was 4.0 μm from the outer surface. This corresponds to 23% of the thickness of the side margin. The ratio of the thickness of the high concentration portion in the cover layer/thickness of the high concentration portion in the side margin was 0.75. Other conditions were the same as in Example 1.

(Comparative example 1) In Comparative Example 1, no color tone adjustment component was added to the side margin and cover layer. After firing, the thickness of the cover layer was 17 μm. The thickness of the side margin was 13 μm. Other conditions were the same as in Example 1.

(Comparative example 2) In Comparative Example 2, the dipping time was 600 seconds. The impregnation depth of the Si component was deeper than 17 μm. After firing, the thickness of the cover layer was 17 μm. The thickness of the side margin was 13 μm. The range of the high concentration portion in the cover layer was greater than 17 μm from the outer surface. This exceeds 100% of the thickness of the cover layer. The range of the high concentration portion in the side margin was wider than 13 μm from the outer surface. This exceeds 100% of the side margin thickness. Other conditions were the same as in Example 1.

(Comparative example 3) In Comparative Example 3, the dipping time was 300 seconds. The impregnation depth of the Si component was 15 μm. After firing, the thickness of the cover layer was 17 μm. The thickness of the side margin was 13 μm. The range of the high concentration portion in the cover layer was 16 μm from the outer surface. This exceeds 100% of the thickness of the cover layer. The range of the high concentration portion in the side margin was 13 μm from the outer surface. This exceeds 100% of the side margin thickness. The ratio of the thickness of the high concentration portion in the cover layer/thickness of the high concentration portion in the side margin was 1.07. Other conditions were the same as in Example 1.

Table 1 shows the conditions of Examples 1 to 8 and Comparative Examples 1 to 3.

TABLE 1

| | | | | AFTER FIRING | | | | | | |
|---|---|---|---|---|---|---|---|---|---|---|
| | | | | | | RAGE OF HIGH | | RATIO OF HIGH | | |
| | | | | | | CONCENTRATION | | CONCENTRATION | | |
| | | | IMPREGNA- | THICKNESS | | PORTION | | PORTION | | |
| | | DIPPING | TION | | SIDE | | SIDE | | SIDE | THICK- |
| | | TIME | DEPTH | COVER | MARGIN | COVER | MARGIN | COVER | MARGIN | NESS |
| | ADDITIVE | (sec) | (μm) | (μm) | (μm) | (μm) | (μm) | (%) | (%) | RATIO |
| EXAMPLE 1 | Si | 5 | 1 | 17 | 13 | 1.3 | 1.0 | 6.5 | 8.5 | 1.10 |
| EXAMPLE 2 | Si | 5 | 1 | 21 | 17 | 1.2 | 1.0 | 5.2 | 6.5 | 1.20 |
| EXAMPLE 3 | Si | 60 | 9 | 17 | 13 | 9.1 | 7.5 | 49 | 65 | 1.21 |
| EXAMPLE 4 | Si | 60 | 9 | 21 | 17 | 9.1 | 7.2 | 40 | 49 | 1.26 |
| EXAMPLE 5 | Si | 120 | 12 | 21 | 17 | 13.0 | 12.0 | 62 | 76 | 1.08 |
| EXAMPLE 6 | B | | | 17 | 13 | 5.0 | 4.0 | 30 | 38 | 1.25 |
| EXAMPLE 7 | Al | | | 17 | 13 | 7.0 | 6.0 | 41 | 54 | 1.17 |
| EXAMPLE 8 | Ge | | | 17 | 13 | 3.0 | 4.0 | 18 | 23 | 0.75 |
| COMPARATIVE | — | | | 17 | 13 | — | — | — | — | — |
| EXAMPLE 1 | | | | | | | | | | |
| COMPARATIVE | Si | 600 | 17< | 17 | 13 | 17< | 13< | 100< | 100< | — |
| EXAMPLE 2 | | | | | | | | | | |
| COMPARATIVE | Si | 300 | 15 | 17 | 13 | 16 | 13< | 100< | 100< | 1.07 |
| EXAMPLE 3 | | | | | | | | | | |

(Appearance defect inspection) For each of Examples 1 to 8 and Comparative Examples 1 to 3, 100 samples were inspected for appearance defects. In the appearance defect inspection, samples whose numerical color tone was outside a certain standard range, such as on a gray scale, were determined to be defective. The ratio of the number of samples determined to be defective was defined as the defective determination rate. If the defective determination rate was less than 5%, the appearance defective determination rate was determined to be good “∘”. If the defective determination rate was 5% or more and less than 10%, the appearance defective determination rate was judged to be slightly good “Δ”. If the defective determination rate was 10% or more, the appearance defective determination rate was determined to be defective “x”. The results are shown in Table 2.

In Comparative Example 1, the appearance defect inspection was determined to be defective “x”. This is considered to be because no color tone adjustment component was added to the side margins and cover layer. On the other hand, in all of Examples 1 to 8, the appearance defect inspection was judged to be good. This is considered to be because Si was added as the color tone adjusting component to the side margins and the cover layer.

(capacity change rate) The electrostatic capacity was examined for each of Examples 1 to 8 and Comparative Examples 1 to 3. If the rate of decrease in electrostatic capacity is 5% or more with respect to the electrostatic capacity of Example 1, the capacity decrease rate was determined to be defective “x”. If the rate of decrease in electrostatic capacity is 3% or more and less than 5%, the capacity decrease rate was determined to be slightly good “Δ”. If the capacity decrease rate was less than 3%, the capacity change rate was determined to be good “∘”. The results are shown in Table 2.

In Comparative Examples 2 and 3, the capacity change rate was determined to be defective “x”. This is considered to be because the high concentration portion of the color tone adjustment component was formed over the entire side margin and cover layer, so that the color tone adjustment component was diffused into the capacity section. On the other hand, in Examples 1 to 8, the rate of change in capacity was determined to be slightly good “Δ” or good “o”. It is thought that this is because a high concentration portion of the color tone adjustment component was formed in a part of the side margin and a part of the cover layer, and the concentration of the color tone adjustment component was low on the capacity section side, suppressing the diffusion of the color tone adjustment component.

It is thought that the reason why the capacity change rate results were better in Examples 1 to 4 and 6 to 8 than in Example 5 is that there was an inflection point in the concentration of the color tone adjustment component in the range of 67% or less of the thickness of the thinner one of the side margin and cover layer from the outer surface.

TABLE 2

| | APPEARANCE | |
|---|---|---|
| | DEFECTIVE | CHANGE RATE OF |
| | DTERMINATION RATE | CAPACITY |
| EXAMPLE 1 | ∘ | ∘ |
| EXAMPLE 2 | ∘ | ∘ |
| EXAMPLE 3 | ∘ | ∘ |
| EXAMPLE 4 | ∘ | ∘ |
| EXAMPLE 5 | ∘ | Δ |
| EXAMPLE 6 | Δ | ∘ |
| EXAMPLE 7 | ∘ | ∘ |
| EXAMPLE 8 | ∘ | ∘ |
| COMPARATIVE | x | ∘ |
| EXAMPLE 1 | | |
| COMPARATIVE | ∘ | x |
| EXAMPLE 2 | | |
| COMPARATIVE | ∘ | x |
| EXAMPLE 3 | | |

Although the embodiments of the present invention have been described in detail, it is to be understood that the various change, substitutions, and alterations could be made hereto without departing from the spirit and scope of the invention.

What is claimed is:

1. A ceramic electronic device comprising:
a multilayer chip having a multilayer portion in which each of a plurality of dielectric layers and each of a plurality of internal electrode layers are alternately stacked,
wherein the plurality of internal electrode layers are extracted alternately to two end faces of the multilayer chip facing each other,
wherein the multilayer chip has a side margin outside a capacity section in which the plurality of dielectric layers and the plurality of internal electrode layers face each other, in a third direction orthogonal to a first direction in which the plurality of internal electrode layers face each other and a second direction in which the two end faces face each other,
wherein the multilayer chip has cover layers of which a main component is ceramic, on an upper face and a lower face of the capacity section in the first direction,
wherein each of the side margin and the cover layers has, on a side of an outer surface, a high concentration portion of a subcomponent of at least one of Si, Mn, Cu, Fe, V, Ni, B, Mg, Ho, Dy, Er, Tm, Yb, Gd, Li, Co, Sm and Y, and
wherein a concentration of the subcomponent of the high concentration portion is higher than that of a portion closer to the capacity section than the high concentration portion.

2. The ceramic electronic device as claimed in claim 1,
wherein the high concentration portion is a portion from an inflection point of the concentration of the subcomponent to the outer surface, and
wherein the inflection point is a point that satisfies dD/dd≥35 when a normalized intensity (D (%)) normalized by setting intensity to intensity/maximum intensity×100 and a distance from the capacity section to the outer surface is d (μm) when acquiring an EPMA line spectrum from the capacity section to the outer surface.

3. The ceramic electronic device as claimed in claim 1, wherein the inflection point is located within a range of 5.2% to 76% from the outer surface with respect to a thinner one of a thickness of the side margin and a thickness of the cover layers.

4. The ceramic electronic device as claimed in claim 2, wherein the concentration of the subcomponent in the high concentration portion is 2.5 at % or more and 9.0 at % or less.

5. The ceramic electronic device as claimed in claim 2, wherein, in the side margin and the cover layer, the concentration of the subcomponent in the portion closer to the capacity section than the high concentration portion is 2.0 at % or more and 6.0 at % or less.

6. The ceramic electronic device as claimed in claim 1, wherein, in the high concentration portion, the subcomponent exists in a form of a single element, an oxide crystal, or glass.

7. The ceramic electronic device as claimed in claim 2, wherein a ratio of a thickness of the high concentration portion of the cover layers to a thickness of the high concentration portion of the side margin is 0.75 or more and 1.26 or less.

8. A ceramic electronic device comprising:
a multilayer chip having a multilayer portion in which each of a plurality of dielectric layers and each of a plurality of internal electrode layers are alternately stacked,
wherein the plurality of internal electrode layers are extracted alternately to two end faces of the multilayer chip facing each other,
wherein the multilayer chip has a side margin outside a capacity section in which the plurality of dielectric layers and the plurality of internal electrode layers face each other, in a third direction orthogonal to a first direction in which the plurality of internal electrode layers face each other and a second direction in which the two end faces face each other,
wherein the multilayer chip has cover layers of which a main component is ceramic, on an upper face and a lower face of the capacity section in the first direction,
wherein each of the side margin and the cover layers has, on a side of an outer surface, a high concentration portion of a subcomponent of at least one of Si, Mn, Cu, Fe, V, Ni, B, Mg, Ho, Dy, Er, Tm, Yb, Gd, Li, Co, Sm and Y,
wherein a concentration of the subcomponent of the high concentration portion is higher than that of a portion closer to the capacity section than the high concentration portion, and
wherein the high concentration portion is located within a range of 5.2% to 76% from the outer surface with respect to a thinner one of a thickness of the side margin and a thickness of the cover layers.

9. A manufacturing method of a ceramic electronic device comprising:
forming each of plurality of internal electrode patterns on each of a plurality of dielectric green sheets;
forming each of a plurality of dielectric patterns around each of the plurality of internal electrode patterns on each of the plurality of dielectric green sheets;
forming a multilayer structure by, in a first direction, stacking the plurality of dielectric green sheets on which the plurality of internal electrode patterns and the plurality of dielectric patterns are formed, so that ends of the plurality of internal electrode patterns are alternately shifted in a second direction;
arranging a subcomponent of at least one of Si, Mn, Cu, Fe, V, Ni, B, Mg, Ho, Dy, Er, Tm, Yb, Gd, Li, Co, Sm and Y on both ends of the multilayer structure in a third direction orthogonal to the first direction and the second direction by attachment or impregnation; and
firing the multilayer structure.

10. The method as claimed in claim 9, wherein a temperature increase rate during the firing the multilayer structure is 1000° C./h or more.
